(19) United States
(12) Patent Application Publication
(10) Pub. No.: US 2025/0031079 A1
(43) Pub. Date: Jan. 23, 2025

(54) WLAN SENSING METHOD AND APPARATUS, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/713,264

(22) PCT Filed: Nov. 26, 2021
(86) PCT No.: PCT/CN2021/133700

§ 371 Date: May 24, 2024

(51) Int. Cl. H04W 24/10; H04W 84/12

(52) U.S. Cl. CPC H04W 24/10; H04W 84/12

(57) ABSTRACT

A Wireless Local Area Network (WLAN) sensing method is applied to an access point (AP) and includes: receiving a sensing session establishment initiating message frame sent by an initiator device; and in response to the sensing session establishment initiating message frame, establishing WLAN sensing measurement with a first station (STA).

### CROSS REFERENCE TO RELATED APPLICATION

This application is a National Stage of International Application No. PCT/CN2021/133700, filed on Nov. 26, 2021, which is incorporated by reference herein in its entireties for all purposes.

### BACKGROUND

With the rapid development of mobile communication technology, wireless fidelity (Wi-Fi) technology has made great progress in terms of transmission rate and throughput. At present, the research content of Wi-Fi technology lies in, for example, 320 Mhz bandwidth transmission, aggregation and coordination of multiple frequency bands, etc., and its main application scenarios include video transmission, augmented reality (AR), virtual reality (VR), and the like.

### SUMMARY

Embodiments of this disclosure relate to the field of mobile communication technologies, and specifically, to a WLAN sensing method and apparatus, an electronic device, and a storage medium. Embodiments of this disclosure provide a WLAN sensing method and apparatus, an electronic device, and a storage medium, so as to solve the problems of wasted spectrum resources and increased time delay caused by STAs serving as sensing initiators.

According to an aspect, some embodiments of this disclosure provide a WLAN sensing method, which is applied to an AP and includes:
receiving a sensing session establishment initiation message frame sent by an initiator; and
establishing, in response to the sensing session establishment initiation message frame, WLAN sensing measurement with a first STA.

According to another aspect, some embodiments of this disclosure further provide a WLAN sensing method, which is applied to an initiator and includes:
determining a sensing session establishment initiation message frame; and
sending the sensing session establishment initiation message frame to an AP, thereby indicating the AP to establish WLAN sensing measurement with a first STA.

According to yet another aspect, some embodiments of this disclosure further provide an AP, including:
a receiving module, configured to receive a sensing session establishment initiation message frame sent by an initiator; and
a responding module, configured to establish, in response to the sensing session establishment initiation message frame, WLAN sensing measurement with a first STA.

According to still another aspect, some embodiments of this disclosure further provide an initiator, including:
a determining module, configured to determine a sensing session establishment initiation message frame; and
a sending module, configured to send the sensing session establishment initiation message frame to an AP, thereby indicating the AP to establish WLAN sensing measurement with a first STA.

According to another aspect, some embodiments of this disclosure further provide a WLAN sensing apparatus, which is applied to an AP and includes:
a message frame receiving module, configured to receive a sensing session establishment initiation message frame sent by an initiator; and
a message frame responding module, configured to establish, in response to the sensing session establishment initiation message frame, WLAN sensing measurement with a first STA.

According to yet another aspect, some embodiments of this disclosure further provide a WLAN sensing apparatus, which is applied to an initiator and includes:
a message frame determining module, configured to determine a sensing session establishment initiation message frame; and
a message frame sending module, configured to send the sensing session establishment initiation message frame to an AP, thereby indicating the AP to establish WLAN sensing measurement with a first STA.

Some embodiments of this disclosure further provide an electronic device, including a memory, a processor, and a computer program stored in the memory and executable on the processor, where the processor is configured to, upon executing the program, implement the method according to one or more embodiments of this disclosure.

Some embodiments of this disclosure further provide a computer-readable storage medium, on which a computer program is stored, where the computer program is used for, upon being executed by a processor, implementing the method according to one or more embodiments of this disclosure.

According to some embodiments of this disclosure, the AP receives the sensing session establishment initiation message frame sent by the initiator and establishes, in response to the sensing session establishment initiation message frame, the WLAN sensing measurement with the first STA. The WLAN sensing measurement is performed through the AP serving as a proxy of the initiator, thereby realizing one-to-many communication between the responder and the STA as the initiator.

Additional aspects and advantages of embodiments of the disclosure will be set forth in part in the description which follows, and will become apparent from the description, or may be learned by practice of the disclosure.

### BRIEF DESCRIPTION OF THE DRAWINGS

In order to more clearly illustrate the technical solutions according to some embodiments of this disclosure, the following will briefly introduce the accompanying drawings to be used in the description of some embodiments of this disclosure. The accompanying drawings in the following description are only some embodiments of this disclosure, other drawings can also be obtained by those skilled in the art according to these drawings without creative labor.

FIG. 1 is a first flowchart of the WLAN sensing method according to some embodiments of this disclosure.

FIG. 2 is a first schematic diagram of the first example according to some embodiments of this disclosure.

FIG. 3 is a second schematic diagram of the first example according to some embodiments of this disclosure.

FIG. 4 is a third schematic diagram of the first example according to some embodiments of this disclosure.

FIG. 5 is a schematic diagram of the second example according to some embodiments of this disclosure.

FIG. 6 is a schematic diagram of the third example according to some embodiments of this disclosure.

FIG. 7 is a second flowchart of the WLAN sensing method according to some embodiments of this disclosure.

FIG. 8 is a schematic structural diagram of the access point according to some embodiments of this disclosure.

FIG. 9 is a first schematic structural diagram of the WLAN sensing apparatus according to some embodiments of this disclosure.

FIG. 10 is a schematic structural diagram of the initiator according to some embodiments of this disclosure.

FIG. 11 is a first schematic structural diagram of the WLAN sensing apparatus according to some embodiments of this disclosure.

FIG. 12 is a schematic structural diagram of the electronic device according to some embodiments of this disclosure.

### DETAILED DESCRIPTION

The term “and/or” in some embodiments of this disclosure describes the association relationship of associated objects, indicating that there may be three relationships. For example, A and/or B may mean three cases: A exists alone, both A and B exist, or B exists alone. The character “/” generally indicates that the contextual objects are in an “or” relationship.

The term “multiple/plurality of” in some embodiments of this disclosure refers to two or more, and other quantifiers are similar.

Reference will now be made in detail to the exemplary embodiments, examples of which are illustrated in the accompanying drawings. When the following description refers to the drawings, the same numerals in different drawings indicate the same or similar elements, unless otherwise indicated. The embodiments described in the following exemplary examples do not represent all embodiments consistent with the present invention. Instead, they are merely examples of apparatuses and methods consistent with aspects of the invention as recited in the appended claims.

The terminologies used in this disclosure are only for the purpose of describing particular embodiments, rather than being intended to limit this disclosure. As used in this disclosure and the appended claims, the singular forms “a”, “the” and “said” are also intended to include the plural forms, unless otherwise indicated. It should also be understood that the term “and/or” as used herein refers to and includes any and all possible combinations of one or more of the associated items as listed.

It should be understood that although the terms “first”, “second”, “third” and the like may be used in this disclosure to describe various information, the information should not be limited to these terms. These terms are only used to distinguish information of the same type from one another. For example, without departing from the scope of this disclosure, first information may also be called second information, and similarly, second information may also be called first information. Depending on the context, for example, the word “if” as used herein could be interpreted as “when” or “upon” or “in response to determining that . . . .”

The following will clearly and completely describe the technical solutions in some embodiments of this disclosure with reference to the accompanying drawings in some embodiments of this disclosure. Obviously, the described embodiments are only some embodiments of this disclosure, not all of them. Based on the embodiments in this disclosure, all other embodiments obtained by those of ordinary skill in the art without making creative efforts fall within the protection scope of this disclosure.

Among the currently researched Wi-Fi technologies, a wireless local area network (WLAN) sensing technology may be supported, for example, in application scenarios such as location discovery, proximity detection, presence detection, and the like in dense environments (e.g., home environment and enterprise environment). In the process of WLAN sensing, identities of a station (STA) and an access point (AP) are usually interchangeable, for example, both can be used as an initiator (SensingInitiator or SensingTransmitter). Upon serving as the SensingInitiator or SensingTransmitter, the AP can communicate with multiple STAs at the same time, but the STA do not have the above functions and can only communicate with a single sensing responder one-to-one. On the one hand, it causes waste of spectrum resources, and on the other hand, it causes delay. For communication scenarios with high latency requirements, the latency requirements may not be met.

Embodiments of this disclosure provide a WLAN sensing method and apparatus, an electronic device, and a storage medium, so as to solve the problems of wasted spectrum resources and increased time delay caused by STAs serving as sensing initiators.

Herein, the method and the apparatus/device are conceived based on the same concept. Since the principle of solving problems of the method and the apparatus/device is similar, the embodiments of the apparatus/device and the method may be referred to each other, and the description will not be repeated.

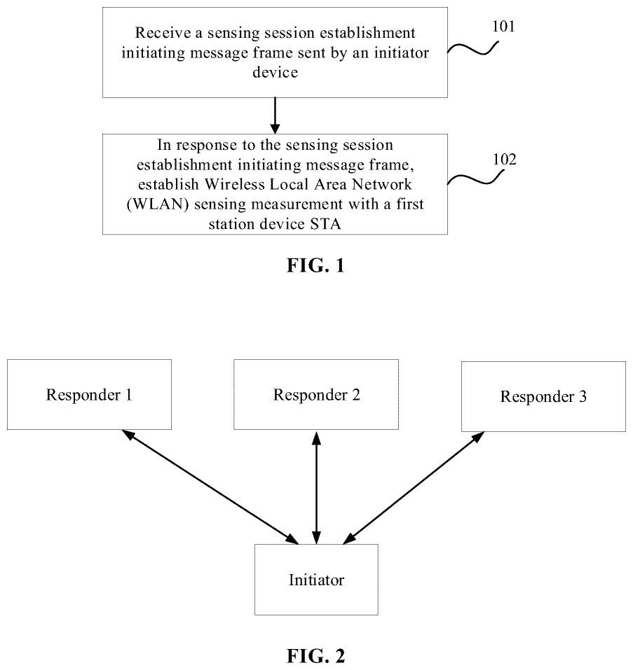

As shown in FIG. 1, some embodiments of this disclosure provide a WLAN sensing method. Optionally, the method can be applied to an access point (AP), and the method includes the following steps.

In step 101, a sensing session establishment initiation message frame sent by an initiator is received.

As a first example, referring to FIG. 2 to FIG. 4, the WLAN Sensing architecture and the WLAN Sensing process applied to the WLAN sensing method according to some embodiments of this disclosure are firstly introduced.

FIG. 2 shows a schematic diagram of the WLAN Sensing architecture. In some embodiments, the sensing initiator initiates WLAN Sensing (e.g., initiates a WLAN sensing session), and there may be multiple sensing responders (or sensing receivers) responding to it, as shown by responder 1, responder 2, and responder 3 in FIG. 2. When the sensing initiator initiates WLAN Sensing, multiple associated or non-associated WLAN Sensing responders can respond.

Referring to FIG. 3, the sensing initiator and the sensing responder(s) communicate through a communication connection, as shown by the communication connection S1. The sensing responders communicate with each other through the communication connection S2.

Herein, each sensing initiator may be a client; and each sensing responder (in this example, sensing responder 1 to sensing responder 3) may be a station (STA). STA can assume multiple roles in the WLAN sensing process. For example, in the WLAN sensing process, the sensing initiator may be a sensing transmitter, a sensing receiver, or both of them, or neither of them. In the WLAN sensing process, the sensing responder may also be a sensing transmitter, a sensing receiver or both of them.

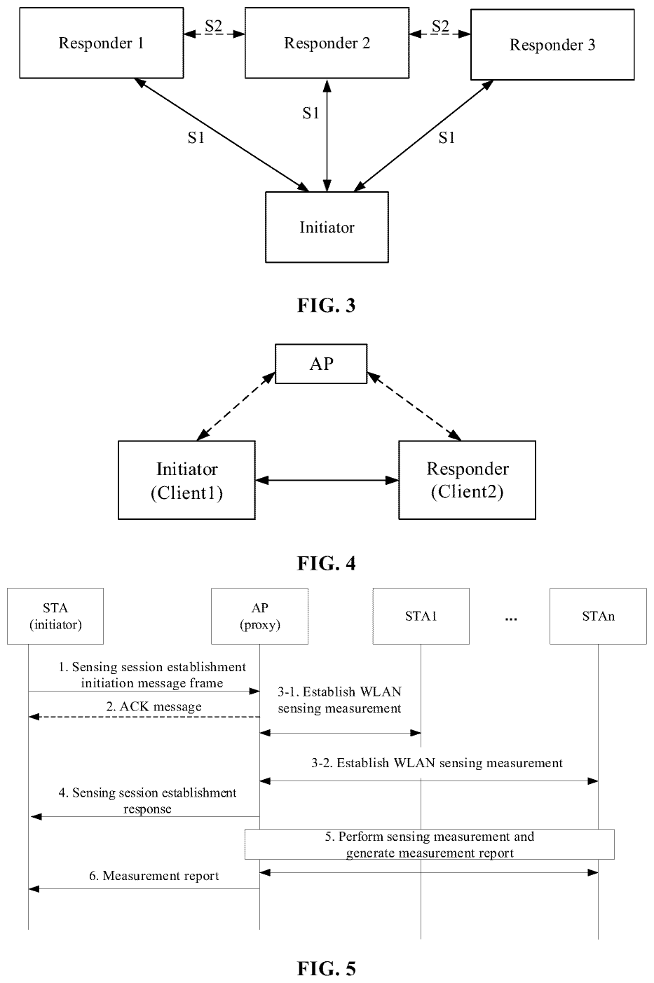

As another architecture, as shown in FIG. 4, the sensing initiator and the sensing responder can both be clients, and the two can communicate with each other by connecting to the same AP. In FIG. 4, Client1 is the sensing initiator, and Client2 is the sensing responder.

During the WLAN sensing process, the initiator (e.g., STA) can send a sensing session establishment initiation message frame to the AP, where the sensing session establishment initiation message frame is used to initiate a sensing session, and the sensing session establishment initiation message frame is, for example, “Sensing Session setup request”. The AP receives the sensing session establishment initiation message frame, and performs sensing measurement on behalf of the initiator according to the sensing session establishment initiation message frame.

In step 102, in response to the sensing session establishment initiation message frame, a WLAN sensing measurement is established with a first station STA.

The AP establishes the WLAN sensing measurement with the first station STA in response to the sensing session establishment initiation message frame, where the first STA is the responder of the sensing measurement. In this way, during the WLAN sensing process, when the initiator is an STA, although the STA cannot perform one-to-many communication with the responders, the one-to-many communication can be realized by the AP performing sensing measurement on behalf of the initiator, thereby reducing the wasted spectrum resources and delay caused by the STA serving as the initiator for WLAN sensing.

According to some embodiments of this disclosure, the AP receives the sensing session establishment initiation message frame sent by the initiator and establishes, in response to the sensing session establishment initiation message frame, the WLAN sensing measurement with the first STA. The WLAN sensing measurement is performed through the AP serving as a proxy of the initiator, thereby realizing one-to-many communication between the responder(s) and the STA as the initiator. Some embodiments of this disclosure solve the problems of wasted spectrum resources and increased time delay caused by STAs serving as sensing initiators.

As a second example, referring to FIG. 5, FIG. 5 shows an application scenario according to some embodiments of this disclosure. Herein, STA acts as a SensingInitiator; AP acts as a proxy to perform WLAN sensing measurement under multiple connections with STAT to STAn; and STAT to STAn are responders of the sensing session. As shown in FIG. 5, it mainly includes the following steps.

In step 1, the STA sends a sensing session establishment initiation message (sensing session setup request) to the AP.

In step 2, the AP feeds back an ACK message.

Thereafter, the AP executes steps 3-1 and 3-2 to establish WLAN sensing measurement with multiple STAs respectively (sensing measurement setup).

In step 4, the AP sends a sensing session establishment response (sensing session setup response) to the STA.

In step 5, sensing measurement is performed between the AP and multiple responders and a measurement report is generated (measurement procedure and measurement report).

In step 6, the AP sends the measurement report to the STA.

In some embodiments, after receiving the sensing session establishment initiation message frame sent by the initiator, the method includes:
feeding back an acknowledgment (ACK) message to the initiator, where the ACK message indicates that the AP has received the sensing session establishment initiation message frame.

After the AP receives the sensing session establishment initiation message frame, it feeds back the ACK message to the initiator. As shown in step 2 of FIG. 5, the AP feeds back the ACK message to the initiator, and the ACK message indicates that the AP has received the sensing session establishment initiation message frame sent by the initiator.

In some embodiments, the sensing session establishment initiation message frame includes first parameter information, and the first parameter information includes at least one of the following:
bandwidth information, NSS quantity information, period information, measurement device information, first timeout information indicating the AP to receive a feedback message, second timeout information indicating the AP to send a response message, sensing type information, first indication information indicating that whether the initiator participates in the sensing measurement.

Herein, the bandwidth information indicates the bandwidth required for WLAN sensing measurement. For example, in the spectrum below 7 GHz, the bandwidth is 20 MHz, 40 MHz, 80 MHz, 160 MHz, 320 MHz, or the like; in the 60 GHz spectrum, the bandwidth is 2160 MHz, 4320 MHZ, 6480 MHz, 8640 MHz, or the like. The NSS indicates the number of spatial streams of WLAN sensing measurement, which identifies the number of spatial streams of NDP as sent or received, for example, NSS is 2, 3, or the like. The period information indicates the measurement period information of WLAN sensing measurement. The first timeout information indicates the time information for the AP to receive the feedback message, and the AP receives the feedback message within the time indicated by the first timeout information. Optionally, the above-mentioned parameter may come from indication of an upper-layer application. For example, it is about 20 seconds.

The second timeout information indicates timeout information for the AP to send the response message, and the AP sends the response message within the time indicated by the second timeout information, Optionally, the second timeout information may be set by the AP For example, it is 200 milliseconds. Optionally, the second timeout information is smaller than the first timeout information.

The sensing type information indicates whether the current WLAN sensing is uplink sensing or downlink sensing, that is, whether it is TB-based (based on triggered) sensing measurement or Non-TB (based on non-triggered) sensing measurement.

The first indication information indicates whether the initiator participates in the sensing measurement. In other words, the initiator can also participate in the WLAN sensing measurement.

In some embodiments, when the first parameter information includes the sensing type information, said establishing, in response to the sensing session establishment initiation message frame, the WLAN sensing measurement with the first STA includes:
establishing the WLAN sensing measurement with the first STA according to a sensing measurement type indicated in the sensing type information, where the sensing type includes uplink sensing or downlink sensing.

Optionally, if the sensing type is downlink sensing, after the sensing measurement is completed, the initiator sends an NDPA (Null Data Packet Announcement) frame to each first STA, and sends an NDP to the first STA. Then, a trigger frame is sent to receive a measurement sensing feedback of the first STA; or the first STA feeds back the measurement sensing feedback according to the resource in the NDPA frame. If the sensing type is uplink sensing, after the sensing measurement is completed, the initiator sends an NDPA frame to each first STA and, then, sends the trigger frame to the first STAs respectively, so as to receive the NDP sent by the first STAs.

In some embodiments, when the first parameter information includes the first indication information, and the first indication information indicates that the initiator participates in the sensing measurement, then the first STA includes the initiator. As a third example, referring to FIG. 6, FIG. 6 shows another application scenario according to some embodiments of this disclosure. Herein, STA acts as a Sensing Initiator; AP acts as a proxy to perform WLAN sensing measurement under multiple connections with STAT to STAn; STAT to STAn are responders of the sensing session; and the STA also participate in the sensing measurement as a responder. As shown in FIG. 6, it mainly includes the following steps.

In step 1, the STA sends a sensing session establishment initiation message (sensing session setup request) to the AP.

In step 2, the AP feeds back an ACK message.

Thereafter, the AP executes steps 3-1 and 3-2 to establish WLAN sensing measurement with multiple STAs (STA1-STAn) respectively (sensing measurement setup).

Moreover, the AP executes step 3-3 to establish WLAN sensing measurement with the initiating STA.

In step 4, the AP sends a sensing session establishment response (sensing session setup response) to the STA.

In step 5, sensing measurement is performed between the AP and multiple responders and a measurement report is generated (measurement procedure and measurement report).

In step 6, the AP sends the measurement report to the STA.

In some embodiments, after establishing the WLAN sensing measurement with the first station STA, the method includes:
sending a sensing session response to the initiator.

In some embodiments of this disclosure, the sensing session response may also be a sensing session establishment response (sensing session setup response), as shown in step 4 of FIG. 5 and FIG. 6.

The sensing session response includes: a state identifier code, a time synchronization function parameter, and/or time information indicating the first STA to receive the measurement report.

Herein, the state identifier code (Status Code) is used to indicate a state of the AP.

For example, when the state identifier code is a first parameter value, it indicates that the AP accepts the sensing session establishment initiation message frame and the first parameter information. For example, the first parameter value being “11” indicates that the AP accepts the sensing session establishment initiation message frame, and receives parameter configuration of the STA in the first parameter information with respect to the sensing measurement.

When the state identifier code is a second parameter value, it indicates that the AP can perform the WLAN sensing measurement and the WLAN sensing measurement includes second parameter information. For example, the second parameter value being “10” indicates that the AP can perform WLAN sensing measurement, but carries other second parameter information, such as other parameter configurations that meet the parameter configuration requirements in the first parameter information. For example, if the bandwidth requirement in the first parameter information is 20M, and the bandwidth provided in the second parameter information is 40M, then the AP can perform WLAN sensing measurement and a new parameter configuration is provided.

When the status identifier code is a third parameter value, it indicates that the AP refuses to perform the WLAN sensing measurement. For example, the third parameter value being “00” indicates that the AP cannot perform WLAN sensing measurement, for example, the requirements of the first parameter information cannot be satisfied.

Optionally, the time synchronization function parameter (Time Synchronization Function, TSF) indicates the initiator to enter a power-saving (PS) state, and to receive the measurement report sent by the AP upon entering an awake state. The AP may need to feedback TSF parameter information to the STA, so that the STA can enter the PS state after receiving the ACK frame, and then wake up to receive the measurement report fed back by the AP.

In some embodiments, after sending the sensing session response to the initiator, the method includes:
performing the WLAN sensing measurement, and generating the measurement report; as shown in step 5 of FIG. 5 and FIG. 6, the AP performs sensing measurement with multiple responders and generates the measurement report; and
sending the measurement report to the initiator; as shown in step 6 of FIG. 5 and FIG. 6, the AP sends the measurement report to the STA.

In some embodiments, the sensing session establishment initiation message frame includes a first identifier of the sensing session establishment initiation message frame, which is used to identify the sensing session. Optionally, the first identifier may be an identifier of an upper-layer application (e.g., an APP).

In some embodiments, the AP is an associated AP or a non-associated AP of the initiator.

As shown in FIG. 2, the responder 1, the responder 2 and the responder 3 may be associated or unassociated with the initiator respectively. Herein, “associated” may mean that an associated connection for communication is established between the sensing initiator and the sensing responder, and “non-associated” may mean that no associated connection for communication is established between the sensing initiator and the sensing responder.

According to some embodiments of this disclosure, the AP receives the sensing session establishment initiation message frame sent by the initiator and establishes, in response to the sensing session establishment initiation message frame, the WLAN sensing measurement with the first STA. The WLAN sensing measurement is performed through the AP serving as a proxy of the initiator, thereby realizing one-to-many communication between the responder(s) and the STA as the initiator.

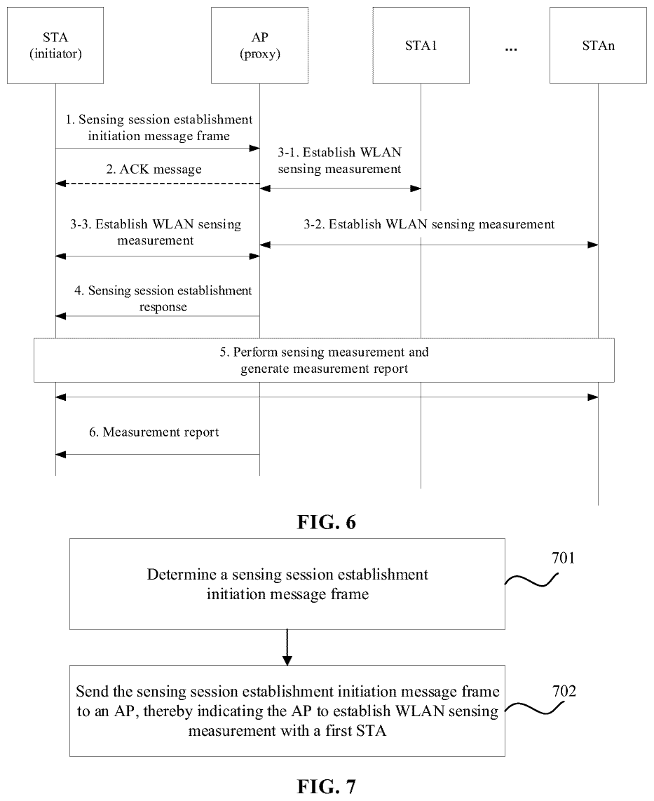

As shown in FIG. 7, some embodiments of this disclosure further provide a WLAN sensing method. Optionally, the method can be applied to the initiator (i.e., the sensing initiator), and includes the following steps.

In step 701, a sensing session establishment initiation message frame is determined.

As a first example, referring to FIG. 2 to FIG. 4, the WLAN Sensing architecture and the WLAN Sensing process applied by the WLAN sensing method according to some embodiments of this disclosure are introduced. For details, the foregoing embodiments can be referred to, and details are not repeated here.

In the WLAN sensing process, the initiator (e.g., STA) determines the sensing session establishment initiation message frame, where the sensing session establishment initiation message frame is used to initiate the sensing session, and the sensing session establishment initiation message frame is, for example, “sensing session setup request”. The initiator may send the sensing session establishment initiation message frame to the AP, and the AP receives the sensing session establishment initiation message frame and performs sensing measurement on behalf of the initiator according to the sensing session establishment initiation message frame.

In step 702, the sensing session establishment initiation message frame is sent to the AP, thereby indicating the AP to establish WLAN sensing measurement with the first STA.

The initiator sends the sensing session establishment initiation message frame to the AP, so that the AP establishes the WLAN sensing measurement with the first STA, which is the responder of the sensing measurement. In this way, during the WLAN sensing process, when the initiator is an STA, although the STA cannot perform one-to-many communication with the responders, the one-to-many communication can be realized by the AP performing sensing measurement on behalf of the initiator, thereby reducing the wasted spectrum resources and delay caused by the STA serving as the initiator for WLAN sensing.

According to some embodiments of this disclosure, the initiator determines and sends the sensing session establishment initiation message frame to the AP, thereby indicating the AP to establish the WLAN sensing measurement with the first STA. The WLAN sensing measurement is performed through the AP serving as a proxy of the initiator, thereby realizing one-to-many communication between the responder(s) and the STA as the initiator. Some embodiments of this disclosure solve the problems of wasted spectrum resources and increased time delay caused by STAs serving as sensing initiators.

In some embodiments, after said sending the sensing session establishment initiation message frame to the AP, the method includes:
receiving an ACK message fed back by the AP, where the ACK message indicates that the AP has received the sensing session establishment initiation message frame.

After sending the sensing session establishment initiation message frame to the AP, the ACK message fed back by the AP is received. As shown in step 2 of FIG. 5, the initiator receives the ACK message fed back by the AP, where the ACK message indicates that the AP has received the sensing session establishment initiation message frame sent by the initiator.

In some embodiments, the sensing session establishment initiation message frame includes first parameter information, and the first parameter information includes at least one of the following:
bandwidth information, number of spatial stream (NSS) quantity information, period information, measurement device information, first timeout information indicating the AP to receive a feedback message, second timeout information indicating the AP to send a response message, sensing type information, first indication information indicating that whether the initiator participates in the sensing measurement.

Herein, the bandwidth information indicates the bandwidth required for WLAN sensing measurement. For example, in the spectrum below 7 GHz, the bandwidth is 20 MHz, 40 MHz, 80 MHz, 160 MHz, 320 MHz, or the like; in the 60 GHz spectrum, the bandwidth is 2160 MHz, 4320 MHZ, 6480 MHz, 8640 MHz, or the like. The NSS indicates the number of spatial streams of WLAN sensing measurement, which identifies the number of spatial streams of NDP (null data packet) as sent or received, for example, NSS is 2, 3, or the like. The period information indicates the measurement period information of WLAN sensing measurement. The first timeout information indicates the time information for the AP to receive the feedback message, and the AP receives the feedback message within the time indicated by the first timeout information. Optionally, the above-mentioned parameter may come from indication of an upper-layer application. For example, it is about 20 seconds.

The second timeout information indicates timeout information for the AP to send the response message, and the AP sends the response message within the time indicated by the second timeout information, Optionally, the second timeout information may be set by the AP. For example, it is 200 milliseconds. Optionally, the second timeout information is smaller than the first timeout information.

The sensing type information indicates whether the current WLAN sensing is uplink sensing or downlink sensing, that is, whether it is TB-based sensing measurement or Non-TB sensing measurement.

The first indication information indicates whether the initiator participates in the sensing measurement. In other words, the initiator can also participate in the WLAN sensing measurement.

In some embodiments, when the first parameter information includes the first indication information, and the first indication information indicates that the initiator participates in the sensing measurement, then the first STA includes the initiator. Referring to FIG. 6, the STA acts as a Sensing Initiator; the AP acts as a proxy to perform WLAN sensing measurements under multiple connections with STAT to STAn.

In some embodiments, after sending the sensing session establishment initiation message frame to the AP, the method includes:
receiving the sensing session response sent by the AP; as shown in step 4 of FIG. 5 and FIG. 6.

The sensing session response includes: a state identifier code, a time synchronization function parameter, and/or time information indicating the first STA to receive the measurement report.

Herein, the state identifier code (Status Code) is used to indicate a state of the AP.

For example, when the state identifier code is a first parameter value, it indicates that the AP accepts the sensing session establishment initiation message frame and the first parameter information. For example, the first parameter value being “11” indicates that the AP accepts the sensing session establishment initiation message frame, and receives parameter configuration of the STA in the first parameter information with respect to the sensing measurement.

When the state identifier code is a second parameter value, it indicates that the AP can perform the WLAN sensing measurement and the WLAN sensing measurement includes second parameter information. For example, the second parameter value being “10” indicates that the AP can perform WLAN sensing measurement, but carries other second parameter information, such as other parameter configurations that meet the parameter configuration requirements in the first parameter information. For example, if the bandwidth requirement in the first parameter information is 20M, and the bandwidth provided in the second parameter information is 40M, then the AP can perform WLAN sensing measurement and a new parameter configuration is provided.

When the status identifier code is a third parameter value, it indicates that the AP refuses to perform the WLAN sensing measurement. For example, the third parameter value being “00” indicates that the AP cannot perform WLAN sensing measurement, for example, the requirements of the first parameter information cannot be satisfied.

In some embodiments, the time synchronization function parameter indicates the initiator to enter a power-saving (PS) state, and to receive the measurement report sent by the AP upon entering an awake state. The AP may feedback TSF parameter information to the STA, so that the STA can enter the PS state after receiving the ACK frame, and then wake up to receive the measurement report fed back by the AP.

In some embodiments, after receiving the sensing session response sent by the AP, the method includes:
receiving the measurement report sent by the AP; as shown in step 6 of FIG. 5 and FIG. 6, the AP sends the measurement report to the STA.

In some embodiments, the sensing session establishment initiation message frame includes a first identifier of the sensing session establishment initiation message frame, which is used to identify the sensing session. Optionally, the first identifier may be an identifier of an upper-layer application (e.g., an APP).

In some embodiments, the AP is an associated AP or a non-associated AP of the initiator. As shown in FIG. 2, the responder 1, the responder 2 and the responder 3 may be associated or unassociated with the initiator respectively. Herein, “associated” may mean that an associated connection for communication is established between the sensing initiator and the sensing responder, and “non-associated” may mean that no associated connection for communication is established between the sensing initiator and the sensing responder.

According to some embodiments of this disclosure, the initiator determines and sends the sensing session establishment initiation message frame to the AP, thereby indicating the AP to establish the WLAN sensing measurement with the first STA. The WLAN sensing measurement is performed through the AP serving as a proxy of the initiator, thereby realizing one-to-many communication between the responder(s) and the STA as the initiator.

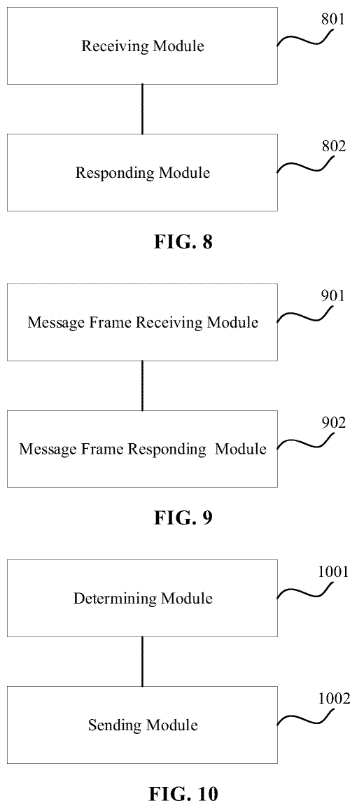

Based on the same principle as the method of AP according to some embodiments of this disclosure, some embodiments of this disclosure further provide an AP As shown in FIG. 8, the AP includes:
a receiving module 801, configured to receive a sensing session establishment initiation message frame sent by an initiator; and
a responding module 802, configured to establish, in response to the sensing session establishment initiation message frame, WLAN sensing measurement with a first STA.

Optionally, in some embodiments of this disclosure, the AP further includes:
an ACK sending module, configured to feed back an ACK message to the initiator, where the ACK message indicates that the AP has received the sensing session establishment initiation message frame.

Optionally, in some embodiments of this disclosure, the sensing session establishment initiation message frame includes first parameter information, and the first parameter information includes at least one of the following:
bandwidth information, NSS quantity information, period information, measurement device information, first timeout information indicating the AP to receive a feedback message, second timeout information indicating the AP to send a response message, sensing type information, first indication information indicating that whether the initiator participates in the sensing measurement.

Optionally, in some embodiments of this disclosure, the responding module 802 includes:
an establishing submodule, configured to establish, when the first parameter information includes the sensing type information, the WLAN sensing measurement with the first STA according to a sensing measurement type indicated in the sensing type information, where the sensing type includes uplink sensing or downlink sensing.

Optionally, in some embodiments of this disclosure, if the first parameter information includes the first indication information, and the first indication information indicates that the initiator participates in sensing measurement, then the first STA includes the initiator.

Optionally, in some embodiments of this disclosure, the AP further includes:
a response sending module, configured to send a sensing session response to the initiator.

The sensing session response includes: a state identifier code, a time synchronization function parameter, and/or time information indicating the first STA to receive a measurement report.

Optionally, in some embodiments of this disclosure, when the state identifier code is a first parameter value, it indicates that the AP accepts the sensing session establishment initiation message frame and the first parameter information; when the state identifier code is a second parameter value, it indicates that the AP can perform the WLAN sensing measurement and the WLAN sensing measurement includes second parameter information; and
when the state identifier code is a third parameter value, it indicates that the AP refuses to perform the WLAN sensing measurement.

Optionally, in some embodiments of this disclosure, the time synchronization function parameter indicates the initiator to enter a power-saving state, and to receive a measurement report sent by the AP upon entering an awake state.

Optionally, in some embodiments of this disclosure, the AP further includes:
a measurement module, configured to perform the WLAN sensing measurement and generate a measurement report; and
a report sending module, configured to send the measurement report to the initiator.

Optionally, in some embodiments of this disclosure, the sensing session establishment initiation message frame includes a first identifier of the sensing session establishment initiation message frame.

Optionally, in some embodiments of this disclosure, the AP is an associated AP or a non-associated AP of the initiator.

According to some embodiments of this disclosure, the receiving module 801 receives the sensing session establishment initiation message frame sent by the initiator, and the responding module 802 establishes, in response to the sensing session establishment initiation message frame, the WLAN sensing measurement with the first STA. The WLAN sensing measurement is performed through the AP serving as a proxy of the initiator, thereby realizing one-to-many communication between the responder(s) and the STA as the initiator.

Referring to FIG. 9, some embodiments of this disclosure further provide a WLAN sensing apparatus, which is applied to an AP and includes:
a message frame receiving module 901, configured to receive a sensing session establishment initiation message frame sent by an initiator; and
a message frame responding module 902, configured to establish, in response to the sensing session establishment initiation message frame, WLAN sensing measurement with a first STA.

The WLAN sensing apparatus may further include other modules in the AP according to the foregoing embodiments, so as to perform other functions of the AP according to the foregoing embodiments, and details are not repeated here.

Based on the same principle as the method according to some embodiment of this disclosure, some embodiments of this disclosure further provide an initiator. As shown in FIG. 10, the initiator includes:
a determining module 1001, configured to determine a sensing session establishment initiation message frame; and
a sending module 1002, configured to send the sensing session establishment initiation message frame to an AP, thereby indicating the AP to establish WLAN sensing measurement with a first STA.

Optionally, in some embodiments of this disclosure, the initiator further includes:
an ACK receiving module, configured to receive an ACK message fed back by the AP, where the ACK message indicates that the AP has received the sensing session establishment initiation message frame.

Optionally, in some embodiments of this disclosure, the sensing session establishment initiation message frame includes first parameter information, and the first parameter information includes at least one of the following:
bandwidth information, NSS quantity information, period information, measurement device information, first timeout information indicating the AP to receive a feedback message, second timeout information indicating the AP to send a response message, sensing type information, first indication information indicating that whether the initiator participates in the sensing measurement.

Optionally, in some embodiments of this disclosure, if the first parameter information includes the first indication information, and the first indication information indicates that the initiator participates in sensing measurement, the first STA includes the initiator.

Optionally, in some embodiments of this disclosure, the initiator further includes:
a response receiving module, configured to receive a sensing session response sent by the AP.

The sensing session response may include: a state identifier code, a time synchronization function parameter, and/or time information indicating the first STA to receive a measurement report.

Optionally, in some embodiments of this disclosure, the time synchronization function parameter indicates the initiator to enter a power-saving state and to receive the measurement report sent by the AP upon entering an awake state.

Optionally, in some embodiments of this disclosure, the initiator further includes:
a report receiving module, configured to receive a measurement report sent by the AP.

Optionally, in some embodiments of this disclosure, the sensing session establishment initiation message frame includes a first identifier of the sensing session establishment initiation message frame.

Optionally, in some embodiments of this disclosure, the AP is an associated AP or a non-associated AP of the initiator.

According to some embodiments of this disclosure, the determining module 1001 determines the sensing session establishment initiation message frame, and the sending module 1002 sends it to the AP, thereby indicating the AP to establish the WLAN sensing measurement with the first STA. The WLAN sensing measurement is performed through the AP serving as a proxy of the initiator, thereby realizing one-to-many communication between the responder(s) and the STA as the initiator.

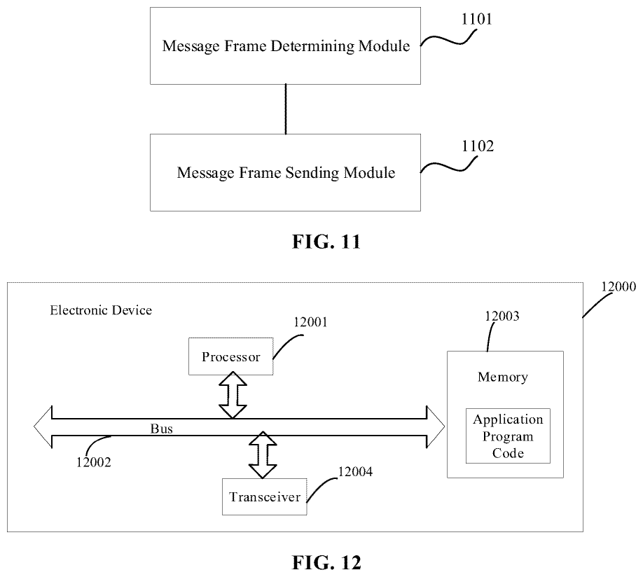

Referring to FIG. 11, some embodiments of this disclosure further provide a WLAN sensing apparatus, which is applied to an initiator and includes:
a message frame determining module, configured to determine a sensing session establishment initiation message frame; and
a message frame sending module, configured to send the sensing session establishment initiation message frame to an AP, thereby indicating the AP to establish WLAN sensing measurement with the first STA.

The WLAN sensing apparatus may further include other modules of the initiator according to the foregoing embodiments, so as to perform other functions of the initiator according to the foregoing embodiments, and details are not repeated here.

In some embodiments, some embodiments of this disclosure further provide an electronic device. As shown in FIG. 12, the electronic device 12000 shown in FIG. 12 may be a server, and includes: a processor 12001 and a memory 12003. In some embodiments, the processor 12001 is connected to the memory 12003, for example, through a bus 12002. Optionally, the electronic device 12000 may further include a transceiver 12004. It should be noted that, in practical applications, the number of transceiver 12004 is not limited to one, and the structure of the electronic device 12000 is not limited to the embodiments illustrated in this disclosure.

The processor 12001 can be CPU (Central Processing Unit), general processor, DSP (Digital Signal Processor), ASIC (Application Specific Integrated Circuit), FPGA (Field Programmable Gate Array); or other programmable logic devices, transistor logic devices, hardware components; or any combination thereof, which can implement or execute the various illustrative logical blocks, modules and circuits described in connection with this disclosure. The processor 12001 may also be a combination that implements computing functions, for example, a combination of one or more microprocessors, a combination of DSP and a microprocessor, or the like.

The bus 12002 may include a path for carrying information between the components described above. The bus 12002 may be a PCI (Peripheral Component Interconnect) bus, an EISA (Extended Industry Standard Architecture) bus, or the like. The bus 12002 can be divided into address bus, data bus, control bus and so on. For ease of representation, only one thick line is used in FIG. 12, but it does not mean that there is only one bus or one type of bus.

The memory 12003 can be ROM (Read Only Memory) or other types of static storage devices that can store static information and instructions, or RAM (Random Access Memory) or other types of dynamic storage devices that can store information and instructions; or can also be EEPROM (Electrically Erasable Programmable Read Only Memory), CD-ROM (Compact Disc Read Only Memory), or other optical disc storage, optical storage (including compressed optical disc, laser disc, optical disc, digital versatile disc, Blu-ray disc, etc.); or can also be magnetic disk storage medium or other magnetic storage device; or can also be any other medium that can be used to carry or store desired program code in the form of instructions or data structures and can be accessed by a computer, but not limited thereto.

The memory 12003 is configured to store application program codes for implementing the solutions of this disclosure, and the execution is controlled by the processor 12001. The processor 12001 is configured to execute the application program codes stored in the memory 12003, so as to realize the contents shown in the foregoing method embodiments.

In some embodiments, the electronic device includes but is not limited to: mobile terminals such as mobile phones, notebook computers, digital broadcast receivers, PDAs (personal digital assistants), PADs (tablet computers), PMPs (portable multimedia players), or vehicle-mounted terminals (e.g., vehicle-mounted navigation terminals); or fixed terminals such as digital TVs, desktop computers, or the like. The electronic device shown in FIG. 12 is only an example, and should not limit the functions and application scope of embodiments of this disclosure.

The server provided in this disclosure may be an independent physical server, or a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, CDN, big data and artificial intelligence platforms. The terminal may be a smart phone, a tablet computer, a laptop computer, a desktop computer, a smart speaker, a smart watch, or the like, but is not limited thereto. The terminal and the server may be connected directly or indirectly through wired or wireless communication, which is not limited in this disclosure.

Some embodiments of this disclosure provide a computer-readable storage medium, on which a computer program is stored. When the computer program is run on a computer, it causes the computer to implement the corresponding content in the foregoing method embodiments.

It should be understood that although the various steps in the flow chart of the accompanying drawings are shown in sequence according to the arrows, these steps are not necessarily executed in sequence in the order indicated by the arrows. Unless otherwise specified herein, there is no strict order restriction on the execution of these steps, and they can be executed in other orders. Moreover, at least some of the steps in the flowcharts of the accompanying drawings may include multiple sub-steps or multiple stages. These sub-steps or stages may not necessarily be executed at the same time, but may be executed at different times, and the order of execution is not necessarily sequential. Instead, they may be performed sequentially or alternately with at least a part of other steps, or sub-steps or stages of other steps.

It should be noted that the computer-readable medium mentioned above in this disclosure may be a computer-readable signal medium or a computer-readable storage medium or any combination thereof. The computer-readable storage medium may be, for example, but not limited to, an electrical, magnetic, optical, electromagnetic, infrared, or semiconductor system, device, or apparatus, or any combination thereof. More specific examples of computer-readable storage medium may include, but are not limited to, electrical connections with one or more wires, portable computer diskettes, hard disks, RAM, ROM, EPROM or flash memory, optical fiber, CD-ROM, optical storage device, magnetic storage device, or any suitable combination of the above. In this disclosure, the computer-readable storage medium may be any tangible medium that contains or stores a program that can be used by or in conjunction with an instruction execution system, apparatus, or device. In this disclosure, the computer-readable signal medium may include a data signal propagated in baseband or as part of a carrier wave carrying computer-readable program code therein. Such propagated data signals may take many forms, including but not limited to electromagnetic signals, optical signals, or any suitable combination of the foregoing. The computer-readable signal medium may also be any computer-readable medium other than the computer-readable storage medium, which can transmit, propagate, or transmit a program for use by or in conjunction with an instruction execution system, apparatus, or device. Program code embodied on the computer-readable medium may be transmitted by any appropriate medium, including but not limited to wires, optical cables, RF (radio frequency), or any suitable combination of the above.

The above-mentioned computer-readable medium may be included in the above-mentioned electronic device, or may exist independently without being incorporated into the electronic device.

The above-mentioned computer-readable medium carries one or more programs, and when the one or more programs are executed by the electronic device, the electronic device is caused to implement the methods according to the above-mentioned embodiments.

According to an aspect of this disclosure, there is provided a computer program product or computer program including computer instructions stored in a computer-readable storage medium. The processor of the computer device reads the computer instructions from the computer-readable storage medium, and executes the computer instructions, thereby causing the computer device to implement the methods according to various embodiments described above.

Computer program code for carrying out the operations of this disclosure can be written in one or more programming languages, or combinations thereof, including object-oriented programming languages (e.g., Java, Smalltalk, C++), and conventional procedural programming language (e.g., “C” or a similar programming language). The program code may be executed entirely on a user computer, or partly on the user computer, or as a stand-alone software package, or partly on the user computer and partly on a remote computer, or entirely on the remote computer or server. In cases a remote computer is involved, the remote computer can be connected to the user computer through any kind of network, including a local area network (LAN) or a wide area network (WAN), or it can be connected to an external computer (e.g., through Internet connection of an Internet service provider).

The flowchart and block diagrams in the drawings illustrate the architecture, functionality, and operation of possible embodiments of systems, methods and computer program products according to various embodiments of this disclosure. In this regard, each block in a flowchart or block diagram may represent a module, program segment, or portion of code that contains one or more logical functions for implementing specified executable instructions. It should also be noted that, in some alternative embodiments, the functions noted in the block may occur out of the order noted in the drawings. For example, two blocks shown in succession may, in fact, be executed substantially concurrently, or they may sometimes be executed in the reverse order, depending upon the functionality involved. It should also be noted that each block of the block diagrams and/or flowchart illustrations, and combinations of blocks in the block diagrams and/or flowchart illustrations, can be implemented by a dedicated hardware-based system that performs the specified functions or operations, or can be implemented by a combination of dedicated hardware and computer instructions.

The modules involved in some embodiments described in this disclosure may be implemented by software or by hardware. Herein, the name of the module does not constitute a limitation of the module itself under certain circumstances. For example, module A may also be described as “module A for performing an operation B”.

The above description is only a preferred embodiment of this disclosure and an illustration of the applied technical principle. Those skilled in the art should understand that the disclosure scope involved in this disclosure is not limited to the technical solution formed by the specific combination of the above-mentioned technical features, but also covers the technical solutions formed by the above-mentioned technical features and other technical solutions formed by any combination of equivalent features. For example, a technical solution formed by replacing the above-mentioned features with technical features with similar functions disclosed (but not limited to) in this disclosure.

1. A wireless local area network (WLAN) sensing method comprising:
receiving, by an access point (AP), a sensing session establishment initiation message frame sent by an initiator; and
establishing, by the AP, in response to the sensing session establishment initiation message frame, WLAN sensing measurement with a first station (STA).

2. The WLAN sensing method according to claim 1, further comprising:
feeding back an acknowledgment (ACK) message to the initiator, wherein the ACK message indicates that the AP has received the sensing session establishment initiation message frame.

3. The WLAN sensing method according to claim 1, wherein the sensing session establishment initiation message frame comprises first parameter information, and the first parameter information comprises at least one:
bandwidth information, number of spatial stream (NSS) quantity information, period information, measurement device information, first timeout information indicating the AP to receive a feedback message, second timeout information indicating the AP to send a response message, sensing type information, or first indication information indicating that whether the initiator participates in the sensing measurement.

4. The WLAN sensing method according to claim 3, wherein the first parameter information comprises the sensing type information, said establishing, in response to the sensing session establishment initiation message frame, the WLAN sensing measurement with the first STA comprises:
establishing the WLAN sensing measurement with the first STA according to a sensing measurement type indicated in the sensing type information, wherein the sensing measurement type comprises uplink sensing or downlink sensing.

5. The WLAN sensing method according to claim 3, wherein the first parameter information comprises the first indication information, the first indication information indicates that the initiator participates in the sensing measurement, and the first STA comprises the initiator.

6. The WLAN sensing method according to claim 3, further comprising:
sending a sensing session response to the initiator,
wherein the sensing session response comprises at least one of: a state identifier code, a time synchronization function parameter, or time information indicating the first STA to receive a measurement report.

7. The WLAN sensing method according to claim 6, wherein the state identifier code taking a first parameter value indicates that the AP accepts the sensing session establishment initiation message frame and the first parameter information;
the state identifier code taking a second parameter value indicates that the AP is able to perform the WLAN sensing measurement and the WLAN sensing measurement comprises second parameter information; and
the state identifier code taking a third parameter value indicates that the AP refuses to perform the WLAN sensing measurement.

8. The WLAN sensing method according to claim 6, wherein the time synchronization function parameter indicates the initiator to enter a power-saving state and to receive the measurement report sent by the AP upon entering an awake state.

9. The WLAN sensing method according to claim 6, further comprising:
performing the WLAN sensing measurement, and generating the measurement report; and
sending the measurement report to the initiator.

10.-11. (canceled)

12. A wireless local area network (WLAN) sensing method comprising:
determining, by an initiator device, a sensing session establishment initiation message frame; and
sending, by the initiator device, the sensing session establishment initiation message frame to an access point (AP), thereby indicating the AP to establish WLAN sensing measurement with a first station (STA).

13. The WLAN sensing method according to claim 12, further comprising:
receiving an acknowledgment (ACK) message fed back by the AP, wherein the ACK message indicates that the AP has received the sensing session establishment initiation message frame.

14. The WLAN sensing method according to claim 12, wherein the sensing session establishment initiation message frame comprises first parameter information, and the first parameter information comprises at least one of:
bandwidth information, number of spatial stream (NSS) quantity information, period information, measurement device information, first timeout information indicating the AP to receive a feedback message, second timeout information indicating the AP to send a response message, sensing type information, or first indication information indicating that whether the initiator participates in the sensing measurement.

15. The WLAN sensing method according to claim 14, wherein the first parameter information comprises the first indication information, the first indication information indicates that the initiator participates in the sensing measurement, and the first STA comprises the initiator.

16. The WLAN sensing method according to claim 14, further comprising:
receiving a sensing session response sent by the AP,
wherein the sensing session response comprises at least one of: a state identifier code, a time synchronization function parameter, or time information indicating the first STA to receive a measurement report.

17. The WLAN sensing method according to claim 16, wherein the time synchronization function parameter indicates the initiator to enter a power-saving state and to receive the measurement report sent by the AP upon entering an awake state.

18. The WLAN sensing method according to claim 16, further comprising:
receiving the measurement report sent by the AP.

19. The WLAN sensing method according to claim 12, wherein the sensing session establishment initiation message frame comprises a first identifier of the sensing session establishment initiation message frame.

20. The WLAN sensing method according to claim 12, wherein the AP is an associated AP or a non-associated AP of the initiator.

21.-26. (canceled)

27. An access point (AP), comprising a memory and a processor, wherein the memory is configured to store a computer program executable on the processor, and the processor, upon executing the computer program, is configured to:
receive a sensing session establishment initiation message frame sent by an initiator device; and
establish, in response to the sensing session establishment initiation message frame, WLAN sensing measurement with a first station (STA).
